(19) United States
(12) Patent Application Publication
(10) Pub. No.: US 2018/0281761 A1
(43) Pub. Date: Oct. 4, 2018

(54) BRAKE DEVICE FOR VEHICLE

(71) Applicant: TOYOTA JIDOSHA KABUSHIKI KAISHA, Toyota-shi (JP)

(72) Inventor: Yusuke ENNOJI, Toyota-shi (JP)

(73) Assignee: TOYOTA JIDOSHA KABUSHIKI KAISHA, Toyota-shi (JP)

(21) Appl. No.: 15/935,133

(22) Filed: Mar. 26, 2018

(30) Foreign Application Priority Data
Apr. 3, 2017 (JP) 2017-073955

(51) Int. Cl. B60T 8/1755; B60T 8/171; B60T 7/04; B60T 8/32; B60T 8/74; B60T 8/172

(52) U.S. Cl. CPC B60T 8/17551; B60T 8/171; B60T 7/042; B60T 2240/06; B60T 8/74; B60T 8/172; B60T 2220/04; B60T 8/3255

(57) ABSTRACT

A brake device for a vehicle includes: braking devices provided corresponding to right/left wheels, respectively, the braking devices being configured to generate braking forces by pressing forces according to a depression amount of a pedal; a wheel speed sensor configured to detect rotational speeds of the wheels; a pressing force sensor configured to detect the pressing forces; and a control device configured to control the braking force generating devices. The control device is configured to acquire the rotational speeds and the pressing forces in a state where the braking device is performing braking, specify deceleration, based on the acquired rotational speeds, and specify the loads that are supported by the wheels, based on the specified deceleration and the acquired pressing forces and controls the pressing forces corresponding to the right/left wheels such that a difference in deceleration between the right and left wheels becomes smaller, based on the loads.

### INCORPORATION BY REFERENCE

The disclosure of Japanese Patent Application No. 2017-073955 filed on Apr. 3, 2017 including the specification, drawings and abstract is incorporated herein by reference in its entirety.

### BACKGROUND

### 1. Technical Field

The disclosure relates to a brake device for a vehicle.

### 2. Description of Related Art

In a vehicle such as an automobile, braking force generating devices are provided corresponding to respective wheels. The braking force generating device is configured such that an actuator is driven according to an operation of a brake pedal to generate a braking force. For example, Japanese Unexamined Patent Application Publication No. 2011-173521 (JP 2011-173521 A) discloses a brake device for a vehicle, which is provided with a motor for pressing a brake pad against a brake disk, a brake pressure detection unit for detecting a brake pressure when pressing the brake pad, and a wheel speed sensor for detecting a rotational speed of the brake disk. The brake device for a vehicle controls the motor in an opposite phase with respect to a fluctuation of a predetermined detection value.

### SUMMARY

In a vehicles such as an automobile, there is a case where an occupant gets on to be biased toward the right or left side, and there is a case where a load is also loaded to be biased toward the right or left side. When the occupant or the load is unevenly distributed as described above, a difference between right and left loads (hereinafter referred to as support loads) that are supported by right and left wheels occurs. When a braking force generating device is provided on each wheel of the vehicle and a braking force is generated in each braking force generating device, acceleration in a deceleration direction (hereinafter referred to as deceleration) which is substantially proportional to the braking force and substantially inversely proportional to the support load occurs.

In a case where equal braking forces are generated on the right and left wheels of a vehicle in which a difference between the right and left support loads is relatively large, it is considered that relatively large deceleration is generated on the wheel on the side where the support load is relatively light (for example, it is assumed to be the right side), and relatively small deceleration is generated on the wheel on the side where the support load is relatively heavy (for example, it is assumed to be the left side). In a case where different decelerations are generated on the right and left sides as described above, it is considered that a clockwise yawing moment that tries to turn to the right side on which the deceleration is relatively large is generated. In a case where the yawing moment is generated, there is a possibility that it may cause a decrease in traveling stability of the vehicle. From the above, in a brake device for a vehicle, there is a problem that should be alleviated from the viewpoint of further suppressing a decrease in traveling stability regarding uneven distribution of an occupant or a load.

The disclosure provides a brake device for a vehicle, capable of further improving traveling stability regarding uneven distribution of an occupant or a load.

An aspect of the disclosure relates to a brake device for a vehicle. The brake device includes braking force generating devices provided corresponding to right and left wheels of the vehicle, respectively, the braking force generating devices being configured to be controlled independently of each other and to generate braking forces by pressing forces according to a depression amount of a brake pedal, a wheel speed detection unit configured to detect rotational speeds of the wheels, a pressing force detection unit configured to detect the pressing forces, and a control device configured to control the braking force generating devices. The control device is configured to acquire the rotational speeds and the pressing forces in a state where the braking force generating device is performing braking, specify deceleration, based on the acquired rotational speeds, specify loads that are supported by the wheels, based on the specified deceleration and the acquired pressing forces, and control the pressing forces corresponding to the right and left wheels such that a difference in deceleration between the right and left wheels becomes smaller, based on the loads.

According to the aspect of the disclosure, it is possible to perform control so as to make a difference in deceleration between the right and left wheels smaller, based on the loads that are supported by the right and left wheels.

In the brake device according to the aspect of the disclosure, the control device may be configured to perform control so as to make a difference between the pressing forces corresponding to the right and left wheels larger as a difference between the loads of the right and left wheels is larger.

In the brake device according to the aspect of the disclosure, the control device may be configured to specify and store the loads, based on the rotational speeds and the pressing forces acquired at the time of first braking after the start of traveling of the vehicle or at the time of braking after the first braking, and control the pressing forces corresponding to the right and left wheels such that a difference in the deceleration between the right and left wheels becomes smaller, based on the stored loads, at the time of braking after the loads are stored.

In the brake device according to the aspect of the disclosure, the control device may be configured to specify the loads, based on the rotational speeds and the pressing forces acquired at the time of braking in a state where a vehicle speed has exceeded a setting value.

According to the aspect of the disclosure, it is possible to provide a brake device for a vehicle, capable of further improving traveling stability regarding uneven distribution of an occupant or a load.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration diagram showing a vehicle provided with a brake device according to an embodiment;

FIG. 2 is a block diagram showing the brake device according to the embodiment;

FIG. 3 is a plan view showing an example of a braking force generating device of the brake device according to the embodiment;

FIG. 4 is a flowchart showing braking force control of the brake device according to the embodiment;

FIG. 5 is an explanatory diagram for conceptually describing a behavior at the time of braking of a vehicle provided with a brake device of a comparative example; and

FIG. 6 is an explanatory diagram for conceptually describing a behavior at the time of braking of the vehicle provided with the brake device according to the embodiment.

### DETAILED DESCRIPTION OF EMBODIMENTS

A brake device having braking force generating devices which were controlled independently of each other and which are provided corresponding to each of four wheels of a vehicle in order to further improve the characteristics at the time of braking of the vehicle is configured as follows.

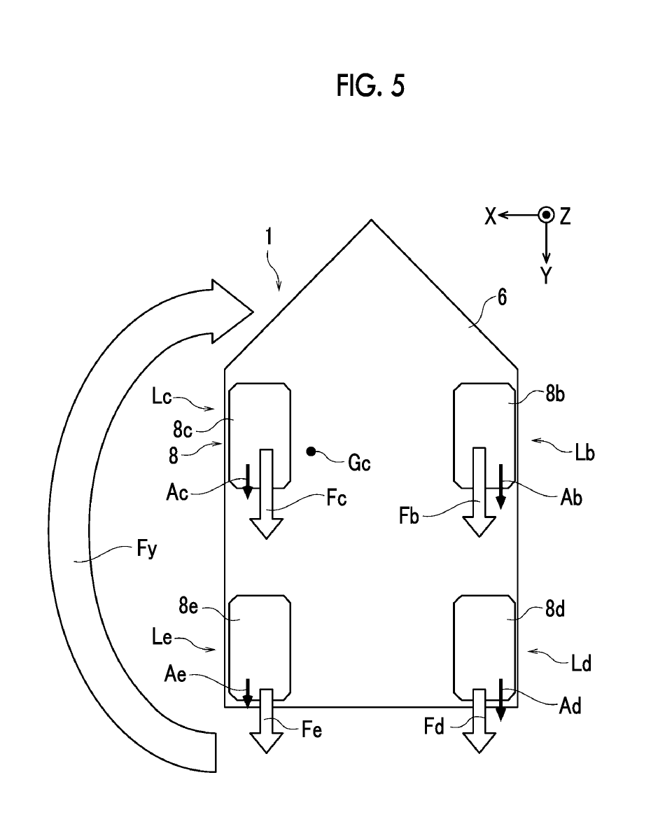

FIG. 5 is an explanatory diagram for conceptually describing the behavior at the time of braking of a vehicle 6 provided with a brake device 1 of a comparative example. In the vehicle 6, braking force generating devices (not shown) that are independently controlled are provided at four wheels 8b, 8c, 8d, 8e, respectively. In the example of FIG. 5, in the vehicle 6, an occupant or a load is positioned to be biased toward the left side, and the center of gravity Gc of the occupant or the load is present at a position close to the left front wheel 8c. When a load that is supported by the right front wheel 8b is set to be a load Lb and a load that is supported by the left front wheel 8c is set to be a load Lc, the load Lc is larger than the load Lb due to the deviation of the center of gravity Gc.

In the wheel, deceleration that is proportional to a braking force and inversely proportional to a load is generated. Therefore, in a case where equal braking forces Fb, Fc are applied to the right and left front wheels 8b, 8c during traveling in the state described above, relatively large deceleration Ab is generated in the right front wheel 8b and relatively small deceleration Ac is generated in the left front wheel 8c. The phenomenon described above also applies to the rear wheels, and thus relatively large deceleration Ad is generated in the right rear wheel 8d and relatively small deceleration Ae is generated in the left rear wheel 8e. As the result described above, in the vehicle provided with the brake device 1 of the comparative example, there is a possibility that a relatively large yawing moment Fy may act at the time of braking to further lower traveling stability. In the example of FIG. 5, the yawing moment Fy acts in a clockwise direction around a Z-axis of the vehicle 6 when viewed in a plan view. In a case where the relatively large yawing moment Fy acts, it is also conceivable that the vehicle 6 causes clockwise yaw rotation.

The following results were obtained by the above comparative example. (1) In order to further improve traveling stability regarding uneven distribution of an occupant or a load, it is conceivable to further suppress the yawing moment due to an unbalanced load. (2) The yawing moment is caused by applying equal braking forces to the right and left wheels supporting different loads. (3) From the above, by increasing or decreasing the braking forces that are applied to the right and left wheels according to the loads that are supported by the wheels, it is possible to further suppress the yawing moment due to the unbalanced load and further improve the traveling stability. (4) The load that is supported by the wheel can be calculated from the ratio of the deceleration or acceleration to the braking force. For example, the deceleration or acceleration can be specified from a change rate of a rotational speed of the wheel. Therefore, the load that is supported by the wheel can be specified by acquiring the braking force and the rotational speed of the wheel. (5) Since the load that is supported by the wheel changes according to the occupant getting on and off, it is desirable to specify the load each time the vehicle starts traveling.

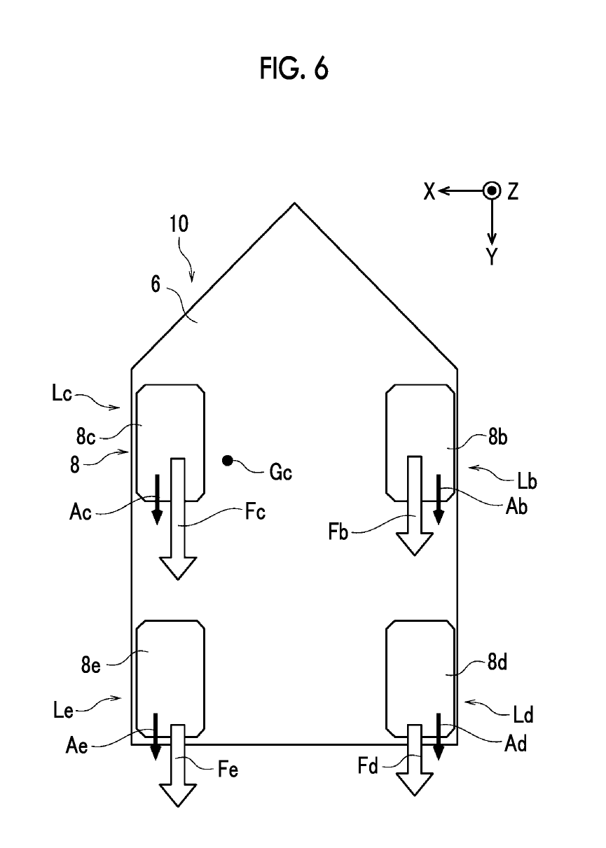

In a brake device 10 according to an embodiment of the disclosure, FIG. 6 is an explanatory diagram for conceptually describing the behavior at the time of braking of the vehicle 6 provided with the brake device 10 according to the embodiment. The brake device 10 is different from the brake device 1 of the comparative example in terms of a control method. The brake device 10 specifies the loads Lb, Lc of the right and left front wheels 8b, 8c from the braking force and the rotational speeds of the wheels during braking and changes the right and left braking forces Fb, Fc according to the specified loads Lb, Lc. For example, in a case where the load Lc is larger than the load Lb due to the deviation of the center of gravity Gc, the brake device 10 makes the braking force Fc that is applied to the left front wheel 8c having the relatively large load Lc larger. With the control as described above, the difference between the decelerations Ab, Ac of the right and left front wheels 8b, 8c becomes smaller, and thus the yawing moment can be further reduced. Further, the configuration as described above is not limited to the front wheels and can be likewise applied to the rear wheels as well. Hereinafter, a detailed configuration of the brake device 10 according to the embodiment will be described.

Hereinafter, the disclosure will be described with reference to the drawings, based on a preferred embodiment. In the embodiment and modification examples, identical or equivalent constituent elements and members are denoted by the same reference numerals, and overlapping description is appropriately omitted. Further, the dimensions of members in each drawing are shown to be appropriately enlarged or reduced in order to facilitate understanding. Further, in each drawing, some of members which are not significant for description of the embodiment are not displayed and are omitted. Further, terms that include ordinal numbers such as first, second, or the like are used in order to describe various constituent elements. However, the terms are used for solely the purpose of distinguishing one constituent element from the other constituent element, and the constituent elements are not limited by the terms.

### EMBODIMENT

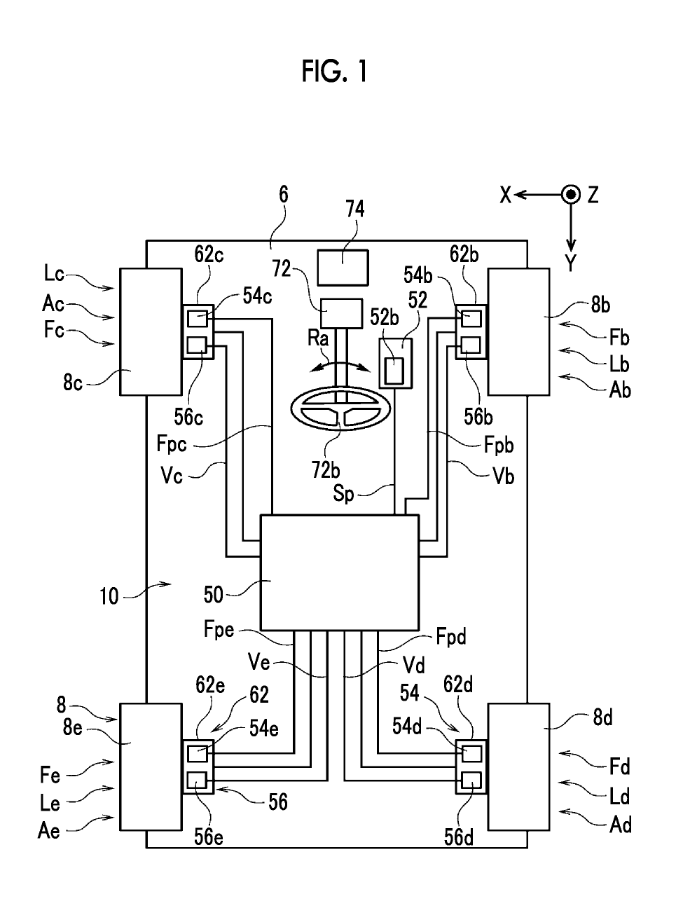

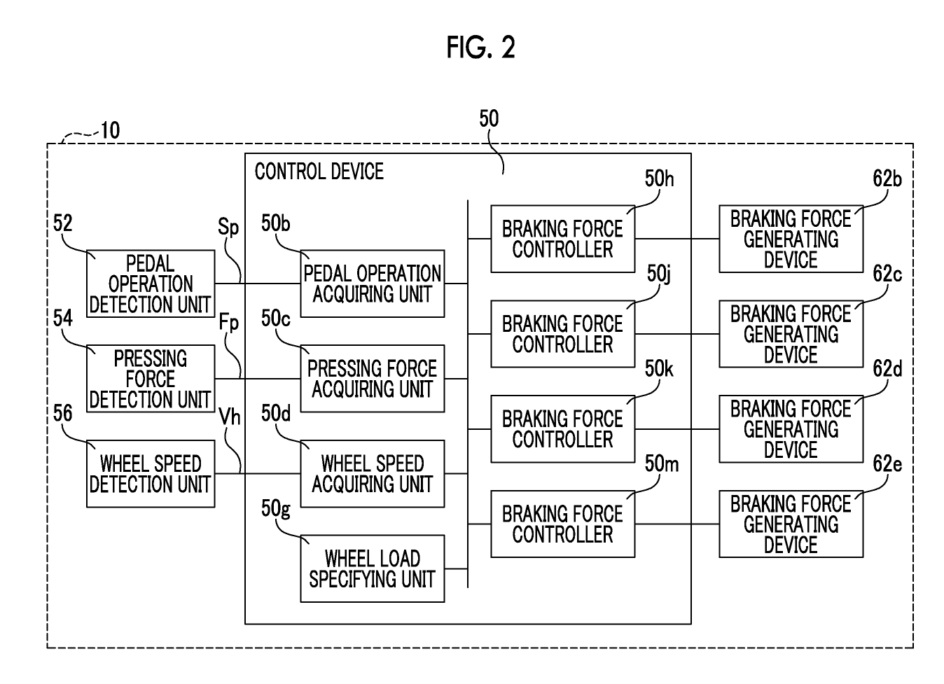

FIG. 1 is a schematic configuration diagram showing the vehicle 6 provided with the brake device 10 according to the embodiment. FIG. 2 is a block diagram showing the brake device 10 according to the embodiment. Hereinafter, description will be made with an XYZ orthogonal coordinate system. The vehicle 6 extends in an X-axis direction and a Y-axis direction when viewed in a plan view. The X-axis direction corresponds to a horizontal right-left direction, the Y-axis direction corresponds to a horizontal front-rear direction, and a Z-axis direction corresponds to a vertical up-down direction. In particular, the X-axis direction corresponds to the width direction of the vehicle 6, the Y-axis direction corresponds to the front-rear direction of the vehicle 6, and the Z-axis direction corresponds to the up-down direction of the vehicle 6.

The vehicle 6 mainly includes wheels 8, the brake device 10, a steering system 72, and a drive system 74. The wheels 8 include the right front wheel 8b, the left front wheel 8c, the right rear wheel 8d, and the left rear wheel 8e. The drive system 74 moves the vehicle 6 forward or backward by rotating the wheels 8, based on the driving force from a prime mover (not shown). The steering system 72 manipulates the traveling direction of the vehicle 6 by changing the directions of the right and left front wheels 8b, 8c, based on a steering angle Ra of a steering wheel 72b. The brake device 10 decelerates or stops the vehicle 6.

Brake Device

The brake device 10 according to the embodiment mainly includes a pedal operation detection unit 52, a braking force generating device 62, a pressing force detection unit 54, a wheel speed detection unit 56, and a control device 50. The braking force generating device 62 generates a braking force by a pressing force according to a depression amount Sp of a brake pedal. The braking force generating device 62 is provided in the vicinity of each of the wheels 8 to correspond to each of the wheels 8. The braking force generating devices 62 are controlled independently of each other.

The pedal operation detection unit 52 detects the depression amount Sp of a brake pedal 52b and outputs the detection result to the control device 50. The pedal operation detection unit 52 can be configured to include, for example, a stop lamp switch that detects ON/OFF of the brake pedal 52b, or a stroke sensor that detects a stroke of the brake pedal 52b.

Braking Force Generating Device

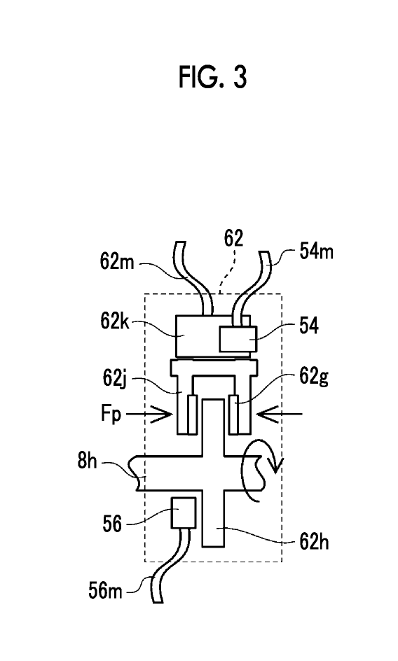

The braking force generating device 62 includes four braking force generating devices 62b, 62c, 62d, 62e provided corresponding to the respective wheels 8. The braking force generating device 62 may be, for example, an electric type brake device. A braking mechanism based on various principles can be used for the braking force generating device 62. FIG. 3 is a plan view showing an example of the braking force generating device 62. As an example, in the embodiment, the braking force generating device 62 includes a caliper 62j that is driven by an electric actuator 62k, and a brake disk 62h that is sandwiched between brake pads 62g incorporated in the caliper 62j. The brake disk 62h rotates integrally with the wheel 8 by an axle 8h. The actuator 62k is connected to the control device 50 and a power supply (not shown) through a cable 62m. The actuator 62k changes pressing forces Fp of the brake pads 62g sandwiching the brake disk 62h therebetween, according to a control signal from the control device 50. With the configuration described above, the braking force generating device 62 can generate a braking force according to the control signal from the control device 50. In particular, the braking force generating device 62 generates a braking force by the pressing force Fp according to the depression amount Sp of the brake pedal.

The braking force generating device 62b is provided corresponding to the right front wheel 8b, and applies a braking force to the right front wheel 8b, based on the control signal from the control device 50. The braking force generating device 62c is provided corresponding to the left front wheel 8c, and applies a braking force to the left front wheel 8c, based on the control signal from the control device 50. The braking force generating device 62d is provided corresponding to the right rear wheel 8d and applies a braking force to the right rear wheel 8d, based on the control signal from the control device 50. The braking force generating device 62e is provided corresponding to the left rear wheel 8e and applies a braking force to the left rear wheel 8e, based on the control signal from the control device 50.

The pressing force detection unit 54 includes four pressing force detection units 54b, 54c, 54d, 54e that are provided inside the braking force generating devices 62b, 62c, 62d, 62e, respectively. The pressing force detection units 54b, 54c, 54d, 54e detect pressing forces Fpb, Fpc, Fpd, Fpe of the braking force generating devices 62b, 62c, 62d, 62e. The pressing forces Fpb, Fpc, Fpd, Fpe are referred to generally as the pressing force Fp. As shown in FIG. 3, the pressing force detection unit 54 is integrally assembled in the braking force generating device 62 and is configured to output a signal according to the pressure of the brake pad 62g. The pressing force detection unit 54 is connected to the control device 50 and a power supply (not shown) through a cable 54m.

The wheel speed detection unit 56 includes four wheel speed detection units 56b, 56c, 56d, 56e that are provided corresponding to the wheels 8b, 8c, 8d, 8e. The wheel speed detection units 56b, 56c, 56d, 56e detect rotational speeds Vb, Vc, Vd, Ve of the wheels 8b, 8c, 8d, 8e and output the detection results to the control device 50. The rotational speeds Vb, Vc, Vd, Ve are referred to generally as a rotational speed Vh. The wheel speed detection unit 56 can be configured to include a rotation sensor that outputs a signal according to the rotational speed of the wheel 8, for example. As shown in FIG. 3, the wheel speed detection unit 56 is integrally assembled in the braking force generating device 62 and is configured to output a signal according to the rotational speed of the axle 8h. The wheel speed detection unit 56 is connected to the control device 50 and a power supply (not shown) through a cable 56m.

Control Device

The control device 50 will be described. Each block of the control device 50 shown in FIG. 2 can be realized by elements including a central processing unit (CPU) of a computer, or a mechanical device in terms of hardware, and can be realized by a computer program or the like in terms of software. However, in the embodiment, functional blocks that are realized by cooperation of the hardware and the software are depicted. Therefore, it will be understood by those skilled in the art who have reviewed this specification that the functional blocks can be realized in various ways by a combination of the hardware and the software.

The control device 50 includes a pedal operation acquiring unit 50b, a pressing force acquiring unit 50c, a wheel speed acquiring unit 50d, braking force controllers 50h, 50j, 50k, 50m, and a wheel load specifying unit 50g. The pedal operation acquiring unit 50b acquires the detection result of the depression amount Sp of the brake pedal 52b from the pedal operation detection unit 52. The pressing force acquiring unit 50c acquires the detection result of the pressing force Fp corresponding to each braking force generating device 62 from the pressing force detection unit 54. The wheel speed acquiring unit 50d acquires the detection result of the rotational speed Vh corresponding to each of the wheels 8 from the wheel speed detection unit 56.

The braking force controller 50h controls the pressing force Fpb of the braking force generating device 62b to increase or decrease the braking force Fb of the right front wheel 8b. The braking force controller 50j controls the pressing force Fpc of the braking force generating device 62c to increase or decrease the braking force Fc of the left front wheel 8c. The braking force controller 50k controls the pressing force Fpd of the braking force generating device 62d to increase or decrease the braking force Fd of the right rear wheel 8d. The braking force controller 50m controls the pressing force Fpe of the braking force generating device 62e to increase or decrease the braking force Fe of the left rear wheel 8e.

Hereinafter, the loads Lb, Lc, Ld, Le that are supported by the respective wheels 8 are referred to generally as a load Lh. The decelerations Ab, Ac, Ad, Ae corresponding to the respective wheels 8 are referred to generally as deceleration Ah. The braking forces Fb, Fc, Fd, Fe corresponding to the respective wheels 8 are referred to generally as a braking force Fh.

The wheel load specifying unit 50g specifies the load Lh supported by each of the wheels 8, based on the acquired rotational speed Vh and pressing force Fp. To this end, the wheel load specifying unit 50g can specify the deceleration Ah corresponding to each of the wheels 8 from the change rate of the rotational speed Vh. Further, the wheel load specifying unit 50g can specify the braking force Fh corresponding to each of the wheels 8 by multiplying the pressing force Fp by a proportionality constant specified from the configuration of the braking force generating device 62. The load Lh corresponding to each of the wheels 8 is proportional to the braking force Fh and inversely proportional to the deceleration Ah. Therefore, the wheel load specifying unit 50g can specify the load Lh corresponding to each of the wheels 8, based on the specified deceleration Ah and the specified braking force Fh. As an example, the control device 50 can incorporate the relationship between the deceleration Ah and the pressing force Fp, and the load Lh in a table form. The control device 50 can acquire the load Lh from the deceleration Ah and the pressing force Fp with reference to the table.

The control device 50 controls the pressing forces Fpb, Fpc corresponding to the right and left front wheels 8b, 8c such that the difference in the deceleration Ah between the right and left front wheels 8b, 8c becomes smaller, based on the load Lh. For example, in a case where the load Lc of the left front wheel 8c is larger than the load Lb of the right front wheel 8b, control is performed so as to make the pressing force Fpc of the left front wheel 8c larger than the pressing force Fpb of the right front wheel 8b. In a case where the load Lb of the right front wheel 8b is larger than the load Lc of the left front wheel 8c, control is performed so as to make the pressing force Fpb larger than the pressing force Fpc.

Also in the rear wheels, in a case where the load of one of the right and left rear wheels 8d, 8e is larger than the load of the other of the right and left rear wheels 8d, 8e, it is possible to perform control so as to make the pressing force of the one wheel larger than the pressing force of the other wheel.

In a case where the difference in the load Lh between the right and left front wheels 8b, 8c is relatively large, the difference in the deceleration Ah between the right and left front wheels 8b, 8c becomes excessive, and thus there is a possibility that a yawing moment larger than usual may occur. Due to the above, in the brake device 10 of the embodiment, the control device 50 may perform control so as to make the difference between the pressing forces Fp corresponding to the right and left front wheels 8b, 8c larger as the difference in the load Lh between the right and left front wheels 8b, 8c is larger. The control device 50 may acquire, for example, the difference in the pressing force Fp by multiplying the difference in the load Lh by a proportional constant. The proportional constant can be acquired by simulation according to desired braking characteristics. As an example, the control device 50 can incorporate the relationship between the difference in the load Lh and the difference in the pressing force Fp in a table form. The control device 50 can acquire the difference in the pressing force Fp from the difference in the load Lh with reference to the table.

Since the load Lh that is supported by the wheel 8 changes according to the occupant getting on and off, it is desirable to specify the load Lh each time the vehicle 6 starts traveling. Due to the above, in the brake device 10 of the embodiment, the control device 50 may specify and store the load Lh, based on the rotational speed Vh and the pressing force Fp acquired at the time of the first braking after the start of traveling of the vehicle 6 or at the time of braking thereafter. It is desirable to correct the pressing force Fp, based on the load Lh, as soon as the load Lh is specified. Due to the above, in the brake device 10 of the embodiment, the control device 50 may control the pressing forces Fpb, Fpc corresponding to the right and left front wheels 8b, 8c such that the difference between the decelerations Ab, Ac of the right and left front wheels 8b, 8c becomes smaller, based on the stored load Lh, at the time of braking after the load Lh is stored.

In a case where the rotational speed Vh or the pressing force Fp is acquired at the time of braking in an excessively low speed state, there is a possibility that the detection accuracy of the rotational speed Vh or the pressing force Fp may be lowered. Due to the above, in the brake device 10 of the embodiment, the control device 50 may specify the load Lh, based on the rotational speed Vh and the pressing force Fp acquired at the time of braking in a state where the vehicle speed exceeds a setting value. The setting value of the vehicle speed in the control described above can be acquired by an experiment according to a desired detection precision.

A change in the position of the center of gravity due to the occupant moving during traveling can be considered. Due to the above, in the brake device 10 of the embodiment, the control device 50 may specify the load Lh, based on the rotational speed Vh and the pressing force Fp acquired again when the vehicle is performing braking after a lapse of a predetermined period from the acquisition of the rotational speed Vh and the pressing force Fp.

Operation

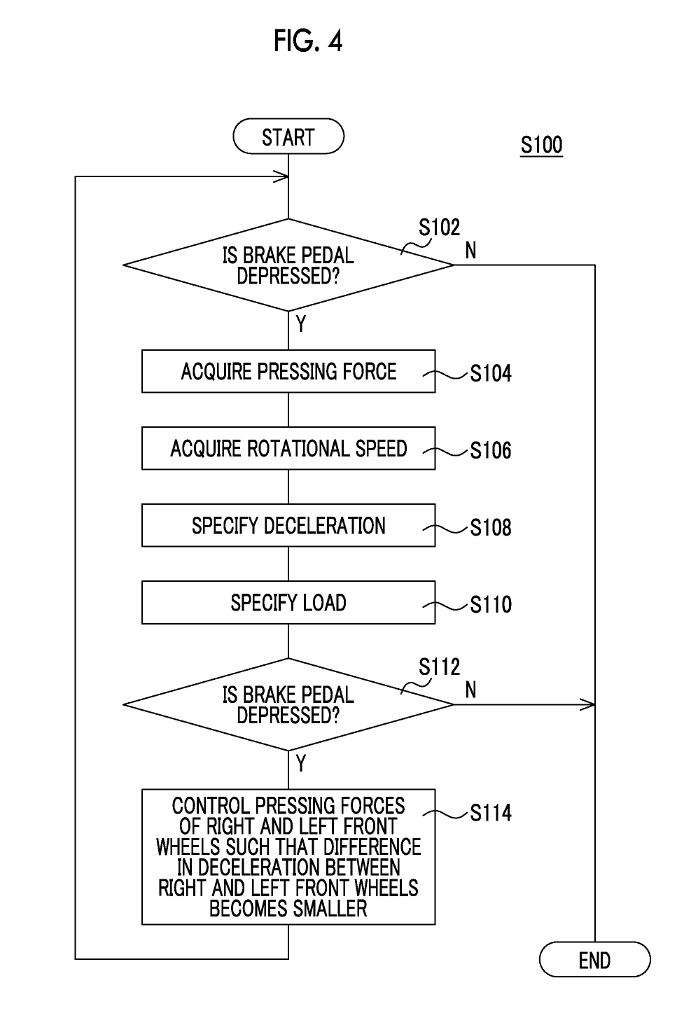

An example of the operation of the brake device 10 of the vehicle configured as described above will be described. FIG. 4 is a flowchart for describing an example of the operation of the brake device 10. FIG. 4 shows processing S100 of controlling the brake device 10. The processing S100 mainly shows the processing of the front wheels. However, the processing of the front wheels can also be likewise applied to the processing of the rear wheels. When the processing S100 is started, the control device 50 determines whether or not the brake pedal 52b is depressed, based on the detection result of the depression amount Sp of the brake pedal 52b acquired from the pedal operation detection unit 52 (step S102). In a case where a determination that the brake pedal 52b is not depressed is made (N in step S102), the control device 50 ends the processing S100.

In a case where a determination that the brake pedal 52b is depressed is made (Y in step S102), the control device 50 acquires the detection result of the pressing force Fp from the pressing force detection unit 54 (step S104). Next, the control device 50 acquires the detection result of the rotational speed Vh from the wheel speed detection unit 56 (step S106). Step S104 and step S106 may be executed at the same time, and step S106 may be executed before step S104. The control device 50 having acquired the rotational speed Vh specifies the deceleration Ah from the change rate of the rotational speed Vh, based on the acquired rotational speed Vh (step S108).

The control device 50 having specified the deceleration Ah specifies the load Lh, based on the specified deceleration Ah and the acquired pressing force Fp (step S110). The control device 50 determines whether or not the brake pedal 52b is depressed, based on the detection result of the depression amount Sp of the brake pedal 52b acquired from the pedal operation detection unit 52 (step S112). In a case where a determination that the brake pedal 52b is not depressed is made (N in step S112), the control device 50 ends the processing S100.

In a case where a determination that the brake pedal 52b is depressed is made (Y in step S112), the control device 50 transfers the processing to step S114. In step S114, the control device 50 controls the pressing forces Fpb, Fpc corresponding to the right and left front wheels 8b, 8c such that the difference in the deceleration Ah between the right and left front wheels 8b, 8c becomes smaller, based on the load Lh (step S114). The control device 50 having executed step S114 returns the processing to the head of step S102. The processing S100 is merely an example, and other processing may be added to the processing described above, steps may be deleted or changed, or the order of steps may be changed.

The operation and effects of the brake device 10 of a vehicle according to the embodiment configured as described above will be described.

The brake device 10 according to the embodiment is provided with the braking force generating devices 62b, 62c that are provided corresponding to the right and left front wheels 8b, 8c of the vehicle 6, respectively, are controlled independently of each other, and generate the braking forces Fb, Fc by the pressing forces Fpb, Fpc according to the depression amount Sp of the brake pedal 52b, the wheel speed detection units 56b, 56c that are devices for detecting the rotational speeds Vb, Vc of the right and left front wheels 8b, 8c, the pressing force detection unit 54b, 54c that are devices for detecting the pressing forces Fpb, Fpc, and the control device 50 that controls the braking force generating devices 62b, 62c. The control device 50 acquires the rotational speeds Vb, Vc and the pressing forces Fpb, Fpc in a state where the braking force generating devices 62b, 62c are performing braking, and specifies the deceleration Ab, Ac, based on the acquired rotational speeds Vb, Vc. The control device 50 specifies the loads Lb, Lc that are supported by the right and left front wheels 8b, 8c, based on the specified decelerations Ab, Ac and the acquired pressing forces Fpb, Fpc, and controls the pressing forces Fpb, Fpc corresponding to the right and left front wheels 8b, 8c such that the difference between the decelerations Ab, Ac of the right and left front wheels 8b, 8c becomes smaller, based on the loads Lb, Lc. According to the configuration described above, it is possible to further improve the traveling stability by specifying the loads Lh that are supported by the wheels 8, based on the detection results of the pressing force detection unit 54 and the wheel speed detection unit 56 provided in the braking force generating device 62, and appropriately distributing the braking forces to the right and left, based on of the loads Lh. It is possible to configure the control device without having an axle load sensor for detecting the load Lh. Compared to a case where the load Lh is detected by the axle load sensor, an installation space for the axle load sensor can be saved, and thus downsizing is facilitated and an increase in cost can be further suppressed. Further, it is possible to further improve control accuracy in the control to make the difference in the deceleration Ah smaller, based on the load Lh specified from the rotational speed Vh and the pressing force Fp, rather than the control using the detection result of the axle load sensor.

The brake device 10 of the embodiment is provided with the braking force generating devices 62d, 62e that are provided corresponding to the right and left rear wheels 8d, 8e of the vehicle 6, respectively, are controlled independently of each other, and generate the braking forces Fd, Fe by the pressing forces Fpd, Fpe corresponding to the depression amount Sp of the brake pedal 52b, the wheel speed detection units 56d, 56e that are devices for detecting the rotational speeds Vd, Ve of the right and left rear wheels 8d, 8e, the pressing force detection unit 54d, 54e that are devices for detecting the pressing forces Fpd, Fpe, and the control device 50 that controls the braking force generating devices 62d, 62e. The control device 50 acquires the rotational speeds Vd, Ve and the pressing forces Fpd, Fpe in a state where the braking force generating devices 62d, 62e are performing braking, and specifies the deceleration Ad, Ae, based on the acquired rotational speeds Vd, Ve. The control device 50 specifies the loads Ld, Le that are supported by the right and left rear wheels 8d, 8e, based on the specified decelerations Ad, Ae and the acquired pressing forces Fpd, Fpe, and controls the pressing forces Fpd, Fpe corresponding to the right and left rear wheels 8d, 8e such that the difference between the decelerations Ad, Ae of the right and left rear wheels 8d, 8e becomes smaller, based on the loads Ld, Le. According to the configuration described above, it is possible to further improve the traveling stability by specifying the loads Lh that are supported by the wheels 8, based on the detection results of the pressing force detection unit 54 and the wheel speed detection unit 56 provided in the braking force generating device 62, and appropriately distributing the braking forces to the right and left, based on of the loads Lh. It is possible to configure the control device without having an axle load sensor for detecting the load Lh. Compared to a case where the load Lh is detected by the axle load sensor, an installation space for the axle load sensor can be saved, and thus downsizing is facilitated, and an increase in cost can be further suppressed. Further, it is possible to further improve control accuracy in the control to make the difference in the deceleration Ah smaller, based the load Lh specified from the rotational speed Vh and the pressing force Fp, rather than the control using the detection result of the axle load sensor.

In the brake device 10 according to the embodiment, the control device 50 may perform control so as to make the difference between the pressing forces Fpb, Fpc corresponding to the right and left front wheels 8b, 8c larger as the difference between the loads Lb, Lc of the right and left front wheels 8b, 8c is larger. According to the configuration described above, in a case where the difference in the load Lh between the right and left front wheels 8b, 8c is relatively large, by performing control so as to make the difference between the pressing forces Fpb, Fpc larger, it is possible to further reduce the yawing moment by further suppressing the difference in the deceleration Ah between the right and left front wheels 8b, 8c.

The control device 50 may perform control so as to make the difference between the pressing forces Fpd, Fpe corresponding to the right and left rear wheels 8d, 8e larger as the difference between the loads Ld, Le of the right and left rear wheels 8d, 8e is larger. According to the configuration described above, in a case where the difference in the load Lh between the right and left rear wheels 8d, 8e is relatively large, by performing control so as to make the difference between the pressing forces Fpd, Fpe larger, it is possible to further reduce the yawing moment by further suppressing the difference in the deceleration Ah between the right and left rear wheels 8d, 8e.

In the brake device 10 according to the embodiment, the control device 50 may specify and store the loads Lb, Lc, based on the rotational speeds Vb, Vc and the pressing forces Fpb, Fpc acquired at the time of the first braking after the start of traveling of the vehicle 6 or at the time of braking thereafter. The control device 50 may control the pressing forces Fpb, Fpc corresponding to the right and left front wheels 8b, 8c such that the difference between the decelerations Ab, Ac of the right and left front wheels 8b, 8c becomes smaller, based on the stored loads Lb, Lc, at the time of braking after the loads Lb, Lc are stored. According to the configuration described above, the rotational speed and the pressing force are acquired every time the vehicle 6 starts traveling, and therefore, even in a case where the load Lh that is supported by the wheel 8 changes due to the occupant getting on and off, it is possible to further reduce the yawing moment by further suppressing the difference in the deceleration Ah between the right and left front wheels 8b, 8c. In a case where the load Lh is specified, the pressing force Fp is immediately corrected based on the load Lh, and therefore, it is possible to appropriately control the difference between the pressing forces Fpb, Fpc.

The control device 50 may specify and store the loads Ld, Le, based on the rotational speeds Vd, Ve and the pressing forces Fpd, Fpe acquired at the time of the first braking after the start of traveling of the vehicle 6 or at the time of braking thereafter. The control device 50 may control the pressing forces Fpd, Fpe corresponding to the right and left rear wheels 8d, 8e such that the difference between the decelerations Ad, Ae of the right and left rear wheels 8d, 8e becomes smaller, based on the stored loads Ld, Le, at the time of braking after the loads Ld, Le are stored. According to the configuration described above, the rotational speed and the pressing force are acquired every time the vehicle 6 starts traveling, and therefore, even in a case where the load Lh that is supported by the wheel 8 changes due to the occupant getting on and off, it is possible to further reduce the yawing moment by further suppressing the difference in the deceleration Ah between the right and left rear wheels 8d, 8e. When the load Lh is specified, the pressing force Fp is immediately corrected based on the load Lh, and therefore, it is possible to appropriately control the difference between the pressing forces Fpd, Fpe.

In the brake device 10 according to the embodiment, the control device 50 may specify the loads Lb, Lc, based on the rotational speeds Vb, Vc and the pressing forces Fpb, Fpc acquired at the time of braking in a state where the vehicle speed has exceeded a setting value. According to the configuration described above, the load Lh is specified based on the rotational speed Vh and the pressing force Fp acquired in a state where the vehicle speed has exceeded the setting value, and therefore, the precision of the specified load Lh can be further improved compared to a case of using the rotational speed or the pressing force acquired in an excessively low speed state.

The control device 50 may specify the loads Ld, Le, based on the rotational speeds Vd, Ve and the pressing forces Fpd, Fpe acquired at the time of braking in a state where the vehicle speed has exceeded a setting value. According to the configuration described above, the load Lh is specified based on the rotational speed Vh and the pressing force Fp acquired in a state where the vehicle speed has exceeded the setting value, and therefore, the precision of the specified load Lh can be further improved compared to a case of using the rotational speed or the pressing force acquired in an excessively low speed state.

The embodiment of the disclosure has been described above. The embodiment described above is illustrative, and it will be understood by those skilled in the art that various modifications and changes can be made within the scope of the claims of the disclosure and that the modification examples and the changes are also within the scope of the claims of the disclosure. Therefore, the description in this specification and the drawings should be treated as being illustrative rather than being restrictive.

Hereinafter, modification examples will be described. In the drawings and description of the modification examples, identical or equivalent constituent elements and members to those of the embodiment are denoted by the same reference numerals. Description overlapping with that of the embodiment will be appropriately omitted and description will be made focusing on configurations different from those in the embodiment.

### First Modification Example

In the embodiment, the example in which the pressing force detection unit 54 is provided in the braking force generating device 62 has been described. However, there is no limitation thereto. The pressing force detection unit 54 may be provided at a location different from the braking force generating device 62.

### Second Modification Example

In the embodiment, the example in which the wheel speed detection unit 56 is provided in the braking force generating device 62 has been described. However, there is no limitation thereto. The wheel speed detection unit 56 may be provided at a location different from the braking force generating device 62. Each of the modification examples exhibits the same operation and effects as those in the embodiment.

What is claimed is:

1. A brake device for a vehicle, the brake device comprising:
braking force generating devices provided corresponding to right and left wheels of the vehicle, respectively, the braking force generating devices being configured to be controlled independently of each other and to generate braking forces by pressing forces according to a depression amount of a brake pedal;
a wheel speed detection unit configured to detect rotational speeds of the wheels;
a pressing force detection unit configured to detect the pressing forces; and
a control device configured to control the braking force generating devices,
wherein the control device is configured to acquire the rotational speeds and the pressing forces in a state where the braking force generating device is performing braking, specify deceleration, based on the acquired rotational speeds, specify loads that are supported by the wheels, based on the specified deceleration and the acquired pressing forces, and control the pressing forces corresponding to the right and left wheels such that a difference in deceleration between the right and left wheels becomes smaller, based on the loads.

2. The brake device according to claim 1, wherein the control device is configured to perform control so as to make a difference between the pressing forces corresponding to the right and left wheels larger as a difference between the loads of the right and left wheels is larger.

3. The brake device according to claim 1, wherein the control device is configured to specify and store the loads, based on the rotational speeds and the pressing forces acquired at a time of first braking after start of traveling of the vehicle or at a time of braking after the first braking, and control the pressing forces corresponding to the right and left wheels such that a difference in the deceleration between the right and left wheels becomes smaller, based on the stored loads, at a time of braking after the loads are stored.

4. The brake device according to claim 1, wherein the control device is configured to specify the loads, based on the rotational speeds and the pressing forces acquired at a time of braking in a state where a vehicle speed has exceeded a setting value.
